(19) United States
(12) Patent Application Publication
(10) Pub. No.: US 2014/0158894 A1
(43) Pub. Date: Jun. 12, 2014

(54) METHOD AND DEVICE USING PHOTOELECTRONS FOR IN-SITU BEAM POWER AND STABILITY MONITORING IN EUV SYSTEMS

(71) Applicant: KLA-Tencor Corporation, Milpitas, CA (US)

(72) Inventors: Li Wang, San Ramon, CA (US); Karl Umstadter, Livermore, CA (US)

(73) Assignee: KLA-Tencor Corporation, Milpitas, CA (US)

(21) Appl. No.: 14/100,109

(22) Filed: Dec. 9, 2013

Related U.S. Application Data
(60) Provisional application No. 61/736,491, filed on Dec. 12, 2012.

(51) Int. Cl. G01T 1/29; G21K 5/00

(52) U.S. Cl. CPC G01T 1/29; G21K 5/00
USPC 250/372; 250/504 R

(57) ABSTRACT

The invention presented is a real time EUV illumination metrology device that includes at least one pair of electrodes mounted on an insulator substrate with an aperture defined by the at least one pair of electrodes and/or the insulator substrate. The electrodes of each of the pairs of electrodes are separated by an arc suppression distance. In one alternate embodiment, the metrology device includes four pairs of electrodes. The device may also include a voltage biasing component to divert unwanted electrons that may distort illumination measurement. Also presented is an EUV illumination system incorporating the metrology device. One object of the invention is to provide a system of real time measurement of an EUV illumination beam.

### CROSS REFERENCE TO RELATED APPLICATIONS

This application claims the benefit priority under 35 U.S.C. §119 (e) from U.S. Provisional Application No. 61/736,491 filed Dec. 12, 2012 which application is incorporated herein by reference in its entirety.

### FIELD OF THE INVENTION

The present invention pertains to the field of EUV illumination systems, particularly to metrology of EUV inspection systems, and more particularly to in situ metrology of EUV inspection systems.

### BACKGROUND OF THE INVENTION

In a complex extreme ultraviolet (EUV) system such as an actinic EUV mask inspection system or an EUV photolithography system, it is important to measure light power, beam position, angular stability, and other parameters. Measurement of these parameters can be used in system calibration, service event triggers, feedback for servo control loops, and inspection algorithms.

One method of measuring some or all of these variables is to detect photoelectron currents generated by EUV photons from outside the system etendue that interact with various electrodes arranged on a single or multiple substrate structures to enable real time and in situ beam metrology (measurement). By real time is meant the actual time during which something takes place as in “The system may partly analyze the data in real time (as it comes in).”

U.S. Pat. No. 7,875,865 to Scholz, et al. discloses an apparatus similar to a pinhole camera having an aperture stop and EUV position sensor to measure the radiation from the source or one of the intermediate images falling on the EUV position sensor. The EUV sensor may be one or more EUV photon sensitive imaging devices such as a quadcell or electrodes which will generate photon induced photoelectrons.

U.S. Pat. No. 7,394,083 to Bowering, et al. discloses a method to measure EUV source power near the intermediate images of the source by introducing photoelectron source material such as gaseous helium, argon, and hydrogen to interact with EUV photons to form photoelectrons, then using a three dimensional electrode structure to guide photoelectrons to a sensor to measure photoelectron current, which represents the EUV power levels.

Both of the methods discussed above require insertion of a device to intercept at least a fraction of the center portion of the EUV beam at source intermediate images, which can cause light transmission loss within the usable system etendue. In other words, the methods cause a system throughput loss for EUV lithography or mask inspection systems. In addition, the Scholz and Bowering methods require a three dimensional structure to guide and collect photoelectrons thus requiring more space for the overall EUV system. Further, the Bowering method must include a separate photoelectron source to the inner space formed by electrodes which can cause extra cost, complexity, and measurement uncertainty.

Thus, there is a need in the field for a method and device to measure different parameters of EUV illumination in-situ and in real time without interfering with the EUV illumination beam itself.

### SUMMARY OF THE INVENTION

The present invention broadly comprises a real time EUV illumination metrology device comprising: an insulator substrate; at least one pair of electrodes mounted on the insulator substrate, the electrodes of each of the at least one pair of electrodes separated by an arc suppression distance; and, an aperture defined by at least one of the at least one pair of electrodes and/or the insulator substrate. In one alternate embodiment, the metrology device includes four pairs of electrodes.

The present invention also broadly comprises an EUV illumination system comprising: an EUV illumination source: a real time EUV metrology device, the real time EUV metrology device including; an insulator substrate; at least one pair of electrodes mounted on the insulator substrate, the electrodes of each of the at least one pair of electrodes separated by an arc suppression distance; and, an aperture defined by at least one of the at least one pair of electrodes and/or the insulator substrate; and, an EUV optics system. The EUV metrology device is positioned between the EUV illumination source and the EUV optics system. In one alternate embodiment, the EUV illumination system includes four pairs of electrodes.

One object of the invention is to provide a system of real time measurement of an EUV illumination beam.

A second object of the invention is to supply a system of EUV illumination measurement that does not disrupt the beam by distorting or diverting a portion of the beam within the system etendue for measurement purposes.

A third object of the invention is to disclose a method and apparatus for preventing or reducing metrology distortions caused by unwanted electrons and/or ions generated by an EUV illumination beam.

### BRIEF DESCRIPTION OF THE SEVERAL VIEWS OF THE DRAWINGS

The nature and mode of the operation of the present invention will now be more fully described in the following detailed description of the invention taken with the accompanying drawing Figures, in which:

FIG. 1 is a plan view of one embodiment of the EUV illumination metrology device of the present invention in which a pair of electrodes is arranged as concentric rings around an aperture;

FIG. 2 is a plan view of an alternate embodiment of the EUV metrology device present invention in which four pairs electrodes are distributed around the periphery of the aperture;

FIG. 3A is a plan view of a second alternate embodiment of the EUV illumination metrology device of the present invention in which a bias ring is placed between the EUV beam source or output and the electrode assembly; and,

FIG. 3B is a side view of the second alternate embodiment of the EUV illumination metrology device showing the bias ring positioned between the mounting substrate and the EUV source and directing the EUV illumination beam onto an electrode mounted on the metrology device.

### DETAILED DESCRIPTION OF EMBODIMENTS OF THE INVENTION

At the outset, it should be appreciated that like drawing numbers on different drawing views identify identical structural elements of the invention. It also should be appreciated that figure proportions and angles are not always to scale in order to clearly portray the attributes of the present invention.

While the present invention is described with respect to what is presently considered to be the preferred embodiments, it is understood that the invention is not limited to the disclosed embodiments. The present invention is intended to cover various modifications and equivalent arrangements included within the spirit and scope of the appended claims.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. It should be appreciated that the term “proximate” is synonymous with terms such as “nearby”, “close”, “adjacent”, “neighboring”, “immediate”, “adjoining”, etc., and such terms may be used interchangeably as appearing in the specification and claims. Although any methods, devices or materials similar or equivalent to those described herein can be used in the practice or testing of the invention, the preferred methods, devices, and materials are now described.

In the present invention, the measurement of EUV beam properties is performed through a device that comprises an arrangement of two or more electrodes that are fabricated from a conducting metal. The electrodes are preferably arranged in one or more pairs with a voltage difference between members of each pair. The electrodes are separated by sufficient distance to prevent arcing between the electrodes (arc suppression distance). The electrodes are mounted on one or more nonconductive insulating substrates, such as ceramics. The electrode pairs surround a clear aperture.

When photons from the EUV beam impinge on the lower voltage electrode in the electrode pairs a photoelectron current is created. Because a vacuum is required in the EUV optical path to reduce EUV photon absorption by air to an acceptable level, a method of quantifying EUV beam parameters using a photoelectron current method provides the advantage of simplicity and flexibility as well as utilizing the vacuum system that is already present in EUV illumination systems. In addition, the photoelectric method has a natural filtering capability in that visible, infrared, and UV photons have little or no signal strength due to the zero or low yield of photoelectrons produced by those photons due to their low energy.

As described below, when a device with the above described electrodes and aperture is placed along the EUV optical beam path to allow the center portion of the EUV beam that represents the etendue of the downstream optical system to pass through the aperture, the number of EUV photons passing through the aperture will have a finite mathematical relationship with the number of photons impinging the electrodes. The exact relationship can be established through some setup time calibration procedures. For example, a downstream EUV sensor such as, but not limited to, an imaging device such as a TDI sensor for an inspection system, may be used to measure directly or indirectly the EUV photons passing through the aperture, i.e. within the system etendue. Once the relationship is established, the photoelectron currents across the electrodes can be used to measure the EUV dosage or power passing through the aperture. Whenever the EUV source or upstream optical components such as the collector is unstable in terms of, for example, source brightness, contamination, and/or position drift, the changes seen on the photoelectron current levels can reflect these changes. Thus, the photoelectron current generated by the impinging EUV photons can be used to monitor source and illuminator stability by connecting the electrodes to appropriate meters and sensors known to those having skill in the art.

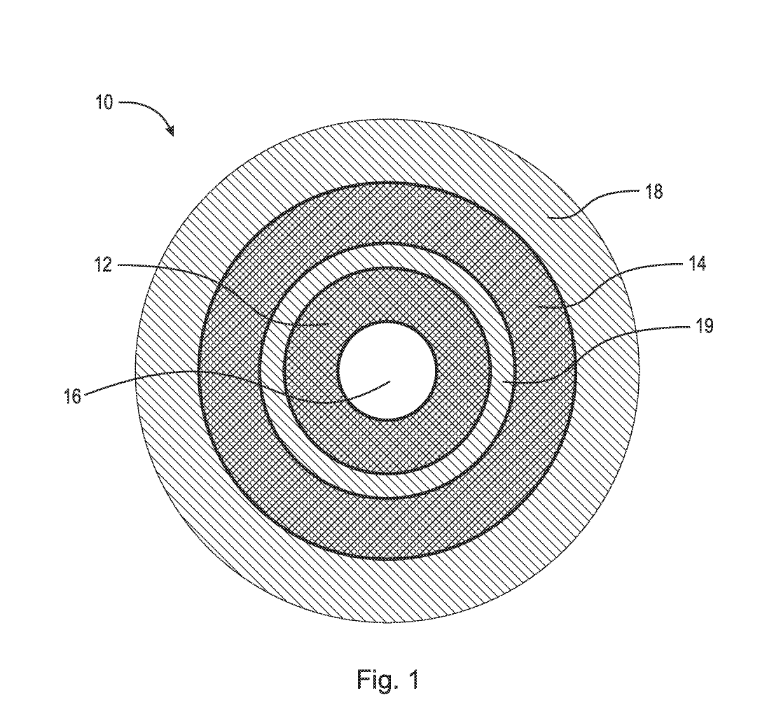

FIG. 1 is a plan view of one embodiment of EUV illumination metrology device 10 (“device 10”) of the present invention in which a pair of electrodes, internal ring electrode 12 (“internal electrode 12”) and outer ring electrode 14 (“outer electrode 14”) are arranged in as concentric rings symmetrically around aperture 16. The electrodes are fabricated from a conductive material such as metal. One example of a suitable material is steel. Internal electrode 12 and outer electrode 14 are mounted on a nonconductive or insulator substrate 18 (“substrate 18”). Examples of suitable fabrication materials for substrate 18 are ceramic materials, wood, and other nonconductive substances. Substrate 18 and/or inner electrode 12 defines aperture 16 with electrodes 12 and 14 arranged symmetrically around aperture 16. Preferably, the inner periphery of inner electrode 12 is coincident (flush) with the perimeter of aperture 16.

Device 10, to include electrodes 12 and 14 and substrate 18 defining aperture 16, may be placed at the intermediate focus (IF) of the EUV illumination system and arranged such that the center of the aperture coincides with the center of the EUV beam at the IF. The intermediate focus is a point(s) within the EUV illumination path in which the EUV light rays are brought to a focal point. Aperture 16 should be sized to not limit the EUV system etendue, but still small enough for inner electrode 12 to be illuminated by the EUV photons having a larger solid angle outside the solid angle defined by the usable EUV system etendue. Outer electrode 14 and inner electrode 12 is separated by gap 19. Gap 19 is sufficiently large to prevent arcing between the two electrodes. In one embodiment, gap 19 may range from 1-5 mm. In an alternate embodiment, gap 19 may range from 2-4 mm.

Inner electrode 12 should have lower voltage than outer electrode 14 to allow the photoelectrons generated from inner electrode 12 to be attracted to outer electrode 14 to form a closed circuit to create electrical current. One of the two electrodes can be grounded while a voltage of required polarity is applied to the other electrode. Electrical current signal measuring devices and/or a voltage generator known to those having skill in the art can be connected to any one or both of the electrodes to measure the photoelectron current. The voltage difference between inner electrode 12 and outer electrode 14 should be sufficient to create adequate electrical field strength across gap 19 to force photoelectrons to pass from inner electrode 12 to outer electrode 14. For example, if 500 volts difference is applied between inner electrode 12 and outer electrode 14, the effective electron travel time is estimated in the order of 10⁻⁵ seconds for a gap 19 in length of 4 mm meaning the response frequency is about 100 kHz. As the discharge produced plasma (DPP) or laser produced plasma (LPP) EUV sources are normally operated from a few to a few tens of kHz, the bandwidth of monitor 10 should be sufficient to measure dosage per EUV source pulse.

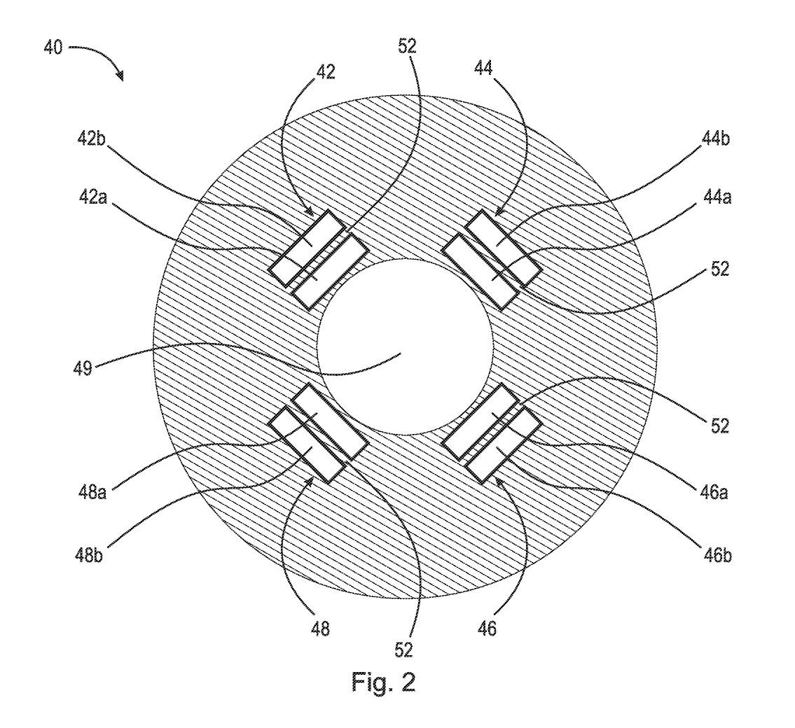

FIG. 2 is a plan view of an alternate embodiment of the EUV illumination metrology device present invention in which four pairs of electrodes are distributed around the periphery of the aperture. Device 40 includes electrode pairs 42, 44, 46, and 48 each including electrode pairs inner electrode 42a and outer electrode 42b, inner electrode 44a and outer electrode 44b, inner electrode 46a and outer electrode 46b, and inner electrode 48a and outer electrode 48b, respectively. In each pair the inner electrode has a lower voltage than the outer electrode in the same pair. Electrodes pairs 42, 44, 46, and 48 are mounted on an insulating substrate 50 as described with device 10. Substrate 50 defines aperture 49. Gaps 52 are found between each electrode of each electrode pair to suppress arcing. Preferably, the pairs of electrodes are evenly distributed on substrate 50 around aperture 49.

When EUV photons outside aperture 49 impinge inner electrodes 42a, 44a, 46a, and 48a, photoelectrons from the inner electrodes have a much higher probability of being attracted to its paired outer electrode than the outer electrodes from the other pairs. For example, photoelectrons from inner electrode 42a will be more likely attracted to outer electrode 42b, than outer electrodes 44b, 46b, and 48b as the electric field between the paired electrodes is greater than between an inner electrode and any other outer electrode. When the four pairs 42, 44, 46, and 48 are made and mounted on substrate 50 equivalently, i.e. same dimension, arranged symmetrically around aperture 49, and with the same applied voltage difference, the four photoelectron currents between the paired inner and outer electrodes should be the same for a rotationally symmetrical beam power density distribution relative to the center of aperture 49. If the EUV beam loses rotational symmetry around the center of aperture 49, due to for example, beam position drift or power distribution change, the four currents will be different from each other. Consequently, the arrangement of electrode pairs in device 40 may detect EUV beam power density differences and beam position drift in addition to total power of the EUV beam functioning when attached to appropriate sensors and meters known to those having skill in the art similar to a photoelectron based quadcell. Persons of skill in the art will recognize that the number, shapes, sizes, and placement of the electrode pairs are not limited to the specific embodiment described, but depends on the specific requirement of each individual EUV system.

A secondary plasma can be created throughout the EUV system chamber by photons that interact with gas in the line of sight to the EUV illumination source. Therefore, if a metrology device is placed in a chamber where the vacuum is not significantly low, electrons can be generated from interaction with the gas along the beam path. These electrons will be collected by surfaces that face the beam path, including the primary collection planes of the electrodes. It would be preferable in such a system to shield photoelectron electrodes from the some portions of the illumination path.

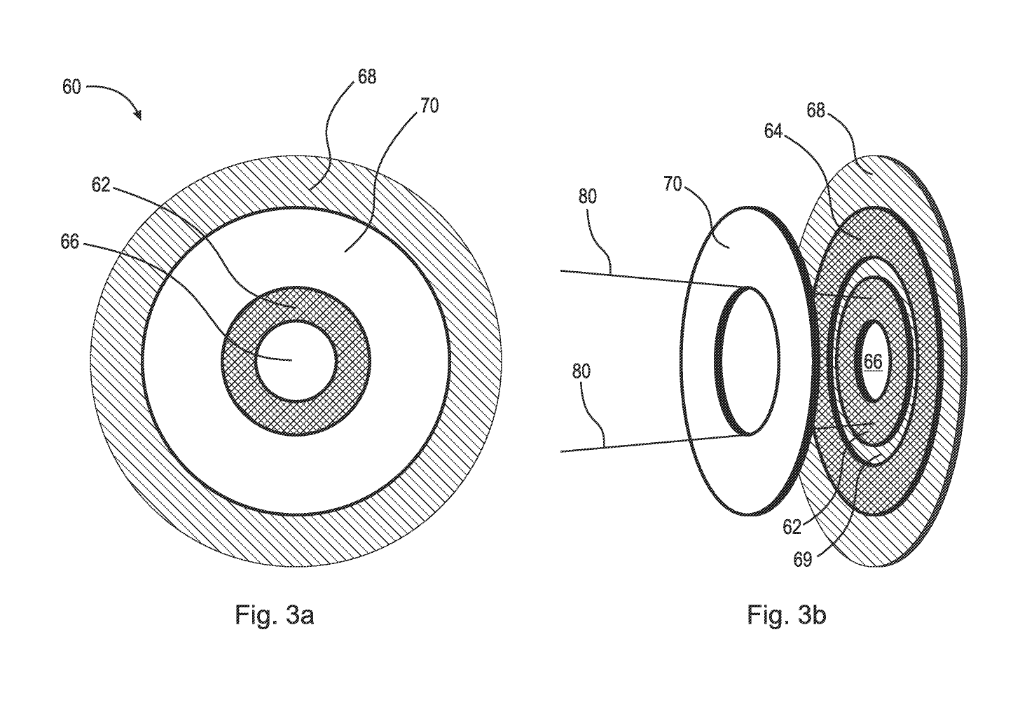

FIG. 3A is a plan view of a second alternate embodiment of the EUV illumination metrology device, in which device 60 includes a bias component 70 placed between the EUV beam source or output and the electrode assembly. In the embodiment shown in FIGS. 3A and 3B, the bias component is in the shape of a bias ring 70. Also seen is mounting substrate 68 defining center aperture 66. Bias ring 70 is centered on aperture 66 meaning that it is symmetrically centered on aperture 66. FIG. 3B is a side view of device 60 showing bias ring 70 positioned between substrate 68 and an EUV source Inner ring electrode 62 and outer ring electrode 64 are mounted on substrate 68 similar to device 10, that is concentrically and symmetrically around aperture 66. Like device 10, gap 69 is placed between electrodes 62 and 64 to prevent arcing between the electrodes.

As shown in FIG. 3B, the inner diameter of bias ring 70 should be sized to permit EUV illumination beam 80 to pass through aperture 66 or impinge only electrode 62 of device 60 while simultaneously blocking the greater portion of the illumination path from which the electrons formed in the secondary plasma are generated. Ring 70 can be biased with a voltage to reject unwanted electrons created in the gas. The biasing voltage may be zero (grounded), positive, or negative. The magnitude of the biasing voltage may be constant or may fluctuate as a function of time. Additionally, geometry can be found that can utilize the electric field generated by the plurality of electrodes to focus photoelectrons created on the detector surface to inner electrode 62.

Persons of skill in the art will recognize that the shapes, sizes, and placement of the electrodes on the metrology device are not limited to the specific embodiments described, but depend on the specific requirement of each individual EUV system such as, but not limited to, EUV actinic inspection and lithography systems. For example, the arrangement of the electrodes can be such that more pairs of electrodes of various shapes along the aperture edge and other areas of the mounting substrate so that better spatial resolution of the beam property change can be achieved, which can be used as control loop feedbacks. The device can also be placed in other places other than on or near intermediate fields. As an example, the device can be placed on the image sensor plane of an EUV inspection system to monitor image field illumination boundary position and its changes as a function of time. It can also be used to observe and/or record in real time optical transmission changes in the system which can be used to track and estimate optical component contamination levels and subsequently initiate cleaning procedures when appropriate. In addition, the bias component may also be utilized with various shapes, sizes, and placements to enable it to shield EUV illumination from electrodes having different shapes and positions than specifically described above.

The present invention provides the advantage of real time measurement of EUV illumination parameters, such as but not limited to power distribution within the EUV illumination beam, beam position drift, and optical system component contamination in real time and without intercepting and/or distorting the beam itself. A second advantage is that the device may be placed in different positions along the beam path to obtain measurements at those different positions.

Thus it is seen that the objects of the invention are efficiently obtained, although changes and modifications to the invention should be readily apparent to those having ordinary skill in the art, which changes would not depart from the spirit and scope of the invention as claimed.

What is claimed is:

1. A real time EUV illumination metrology device comprising:
an insulator substrate;
at least one pair of electrodes mounted on said insulator substrate, said electrodes of each of said at least one pair of electrodes separated by an arc suppression distance; and,
an aperture defined by at least one of said at least one pair of electrodes and/or said insulator substrate.

2. The real time EUV illumination metrology device as recited in claim 1 wherein said at least one pair of electrodes is a plurality of pairs of electrodes.

3. The real time EUV illumination metrology device as recited in claim 2 wherein said at least one pair of electrodes is four pairs of electrodes.

4. The real time EUV illumination metrology device as recited in claim 1 further comprising a current measuring device attached to one member of each of said at least one pair of electrodes.

5. The real time EUV illumination metrology device as recited in claim 1 further comprising a voltage generator attached to one member of each of said at least one pair of electrodes.

6. The real time EUV illumination metrology device as recited in claim 1 further comprising a bias device positioned between said at least one pair of electrodes and an EUV source or an EUV illumination device, wherein a biasing voltage is applied to said bias device.

7. The real time EUV illumination metrology device as recited in claim 6 wherein said biasing voltage is constant.

8. The real time EUV illumination metrology device as recited in claim 6 wherein said biasing voltage fluctuates over time.

9. The real time EUV illumination metrology device as recited in claim 6 wherein said biasing voltage is grounded.

10. The real time EUV illumination metrology device as recited in claim 6 wherein said biasing voltage is positive.

11. The real time EUV illumination metrology device as recited in claim 6 wherein said biasing voltage is negative.

12. An EUV illumination system comprising:
an EUV illumination source:
a real time EUV metrology device, said EUV metrology device including;
an insulator substrate;
at least one pair of electrodes mounted on said insulator substrate, said electrodes of each of said at least one pair of electrodes separated by an arc suppression distance; and,
an aperture defined by at least one of said at least one pair of electrodes and/or said insulator substrate; and,
an EUV optics system;
wherein said EUV metrology device is positioned between said EUV illumination source and said EUV optics system.

13. The EUV illumination system as recited in claim 12 wherein said EUV metrology device is positioned between said EUV illumination source and said EUV optics system.

14. The EUV illumination system as recited in claim 12 wherein said at least one pair of electrodes is plurality of electrode pairs.

15. UV illumination system as recited in claim 14 wherein said at least one pair of electrodes is four pairs of electrodes.

16. The EUV illumination system as recited in claim 12 further comprising a current measuring device attached to one member of each of said at least one pair of electrodes.

17. The EUV illumination system as recited in claim 12 further comprising a voltage generator attached to one member of each of said at least one pair of electrodes.

18. UV illumination system as recited in claim 12 further comprising a bias device positioned between said at least one pair of electrodes and said EUV illumination source wherein a biasing voltage is applied to said bias device.

19. The real time EUV illumination metrology device as recited in claim 18 wherein said biasing voltage is constant.

20. The real time EUV illumination metrology device as recited in claim 18 wherein said biasing voltage fluctuates over time.

21. The real time EUV illumination metrology device as recited in claim 18 wherein said biasing voltage is grounded.

22. The real time EUV illumination metrology device as recited in claim 18 wherein said biasing voltage is positive.

23. The real time EUV illumination metrology device as recited in claim 18 wherein said biasing voltage is negative.

24. The EUV illumination system as recited in claim 12 wherein said EUV illumination system is an EUV actinic inspection system.

25. The EUV illumination system as recited in claim 12 wherein said EUV illumination system is a lithography system.
